(19) United States
(12) Patent Application Publication
(10) Pub. No.: US 2019/0128047 A1
(43) Pub. Date: May 2, 2019

(54) APPARATUS AND METHOD FOR CONTROLLING VEHICLE

(71) Applicant: MANDO CORPORATION, Pyeongtaek-si (KR)

(72) Inventor: Tae Seok KANG, Suwon-si (KR)

(21) Appl. No.: 16/172,114

(22) Filed: Oct. 26, 2018

(30) Foreign Application Priority Data
Oct. 26, 2017 (KR) 10-2017-0140515

(51) Int. Cl. E05F 15/73; B60Q 9/00; B60W 30/06; G05D 1/02

(52) U.S. Cl. CPC E05F 15/73; B60Q 9/00; H04L 67/12; G05D 1/0231; B60W 30/06

(57) ABSTRACT

Disclosed herein is a vehicle control apparatus for preventing a trunk from striking objects when the trunk is opened. An embodiment of the present disclosure provides a vehicle control apparatus including a travel state determination unit configured to collect travel information about a vehicle and determine a travel state of the vehicle based on the collected travel information, a space information generation unit configured to collect scan information about a surrounding space of the vehicle and generate space information about the vehicle based on the collected scan information, a trunk opening allowability determination unit configured to determine whether a trunk of the vehicle is allowed to be opened based on the generated space information when the travel state of the vehicle is determined to be a parked/stopped state or a parking/stopping state, and a control unit configured to generate a control signal for controlling at least one of a notification apparatus and the trunk according to a result of determining whether the trunk is allowed to be opened.

### CROSS REFERENCE TO RELATED APPLICATION

This application claims priority from Korean Patent Application No. 10-2017-0140515, filed on Oct. 26, 2017, which are hereby incorporated by reference for all purposes as if fully set forth herein.

### BACKGROUND OF THE INVENTION

### 1. Field of the Invention

The present disclosure relates to an apparatus and method for controlling a vehicle, and more particularly, to a vehicle control technique for preventing a vehicle from striking objects when opening the trunk of the vehicle.

### 2. Description of the Prior Art

For some vehicles, a space larger than the length of the vehicle may be required depending on the structure and position of a trunk of the vehicle when the trunk is opened. That is, even if the vehicle is parked to be sufficiently separated from obstacles around the vehicle, the vehicle may strike an obstacle around the vehicle when the trunk is opened. In this case, inconvenience may be caused to the driver as the driver needs to move the vehicle again to safely open the trunk.

Particularly, with a recent increase in use of sports utility vehicles (SUVs), the aforementioned issue may be more severe for SUVs because the SUVs require a larger space for opening the rear trunk.

In addition, an automatic parking assist system or autonomous parking system, which is being developed recently, does not consider opening of the rear trunk of a vehicle in determining the parking position of the vehicle, and therefore it may not be possible to open the trunk after the vehicle is automatically parked, thereby, inconvenience may be caused to the user.

### SUMMARY OF THE INVENTION

In this background, the present disclosure is to provide a technique for preventing a trunk from striking objects when the trunk is opened.

The present disclosure is also to provide a technique for determining whether a trunk of a vehicle is allowed to be opened when the vehicle is parked or stopped.

The present disclosure is also to provide a technique for notifying a user of whether a trunk of a vehicle is allowed to be opened when the vehicle is parked or stopped.

The present disclosure is also to provide a technique allowing an automatic parking assist system to consider whether a trunk of a vehicle is allowed to be opened in determining a parking position of the vehicle.

To solve the foregoing problem, an embodiment provides an apparatus for controlling a vehicle, including: a vehicle sensor including at least one of an image sensor disposed on a vehicle to have a field of view for an outside of the vehicle and configured to capture image data and a non-image sensor disposed on the vehicle and configured to capture sensing data to detect at least one of objects disposed adjacent to the vehicle; and a controller including a processor configured to process at least one of the image data captured by the image sensor and the sensing data captured by the non-image sensor, wherein, in response at least in part to at least one of processing of the image data captured by the image sensor and processing of the sensing data captured by the non-image sensor, the controller generates space information about the vehicle based on scan information about a surrounding space of the vehicle, determines whether a trunk of the vehicle is allowed to be opened based on the generated space information with a travel state of the vehicle being a parked/stopped state or a parking/stopping state, and generates a control signal for controlling at least one of a notification apparatus and the trunk according to a result of determining whether the trunk is allowed to be opened.

An embodiment provides a method of controlling a vehicle, the method including: collecting travel information about a vehicle from a vehicle dynamics sensor disposed on the vehicle to detect information related to travel of the vehicle and determining a travel state of the vehicle based on the collected travel information; collecting scan information about a surrounding space of the vehicle using a vehicle sensor including at least one of an image sensor disposed on the vehicle to have a field of view for an outside of the vehicle and configured to capture image data and a non-image sensor disposed on the vehicle and configured to capture sensing data to detect at least one of objects disposed adjacent to the vehicle and generating space information about the vehicle based on the collected scan information; when the travel state of the vehicle is determined to be a parked/stopped state or a parking/stopping state, determining whether a trunk of the vehicle is allowed to be opened based on the generated space information; and generating a control signal for controlling at least one of a notification apparatus and the trunk according to a result of the determining of whether the trunk is allowed to be opened.

An embodiment provides an apparatus for controlling a vehicle, including: a vehicle sensor including at least one of an image sensor disposed on a vehicle to have a field of view for an outside of the vehicle and configured to capture image data and a non-image sensor disposed on the vehicle and configured to capture sensing data to detect at least one of objects disposed adjacent to the vehicle; a vehicle dynamics sensor disposed on the vehicle to detect information related to travel of the vehicle; an autonomous parking system (APS) configured to control the vehicle to move to a parking position by controlling a behavior of the vehicle or a parking assist system (PAS) configured to assist a driver in parking the vehicle; and a domain controller configured to process at least one of the image data captured by the image sensor and the sensing data captured by the non-image sensor and configured to control the APS or the PAS, wherein, in response at least in part to at least one of processing of the image data captured by the image sensor and processing of the sensing data captured by the non-image sensor, the domain controller generates space information about the vehicle based on scan information about a surrounding space of the vehicle, determines whether a trunk of the vehicle is allowed to be opened based on the generated space information with a travel state of the vehicle being a parked/stopped state or a parking/stopping state, and generates a control signal for controlling at least one of a notification apparatus and the trunk according to a result of determining whether the trunk is allowed to be opened.

According to an embodiment of the present disclosure, a trunk of a vehicle may be prevented from striking objects when the trunk is opened.

According to another embodiment of the present disclosure, when a vehicle is parked or stopped, whether the trunk of the vehicle is allowed to be opened may be determined.

According to still another embodiment of the present disclosure, when a vehicle is parked or stopped, the user may be notified of whether the trunk of the vehicle is allowed to be opened.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a configuration diagram of a vehicle control system according to an embodiment of the present disclosure;

FIG. 2 is a block diagram of a vehicle control apparatus according to an embodiment of the present disclosure;

FIG. 3 is a view for explaining an example of determining whether a trunk is allowed to be opened according to an embodiment of the present disclosure;

FIG. 4 is a flowchart of a vehicle control method according to an embodiment of the present disclosure; and

FIG. 5 is a block diagram of a vehicle control apparatus according to another embodiment of the present disclosure.

### DETAILED DESCRIPTION OF THE EXEMPLARY EMBODIMENTS

While the present disclosure is susceptible to various modifications and alternative forms, specific embodiments thereof have been shown by way of example in the drawings and are herein described in detail. It should be understood, however, that the description herein of specific embodiments is not intended to limit the present disclosure to the particular embodiments disclosed, but on the contrary, the present disclosure is to cover all modifications, equivalents, and alternatives falling within the spirit and scope of the present disclosure. In the following description of the present disclosure, a detailed description of known related arts will be omitted when it is determined that the description may make the subject matter of the present disclosure rather unclear. In addition, the singular phrases used in this specification and the claims should generally be construed as meaning “one or more” unless otherwise stated.

Hereinafter, embodiments of the present disclosure will be described in detail with reference to the accompanying drawings. In adding reference numerals to elements in each drawing, the same elements will be designated by the same reference numerals and redundant descriptions thereof may be omitted, although the elements are shown in different drawings.

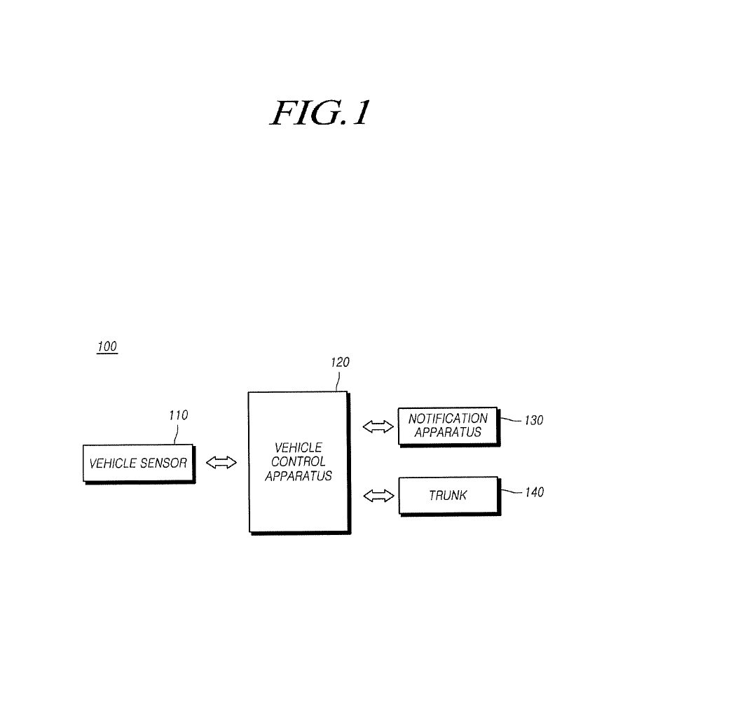

FIG. 1 is a configuration diagram of a vehicle control system according to an embodiment of the present disclosure.

Referring to FIG. 1, a vehicle control system 100 configured to prevent a vehicle from striking objects when the vehicle is opened may include a vehicle sensor 110, a vehicle control apparatus 120, a notification apparatus 130, and a trunk 140.

The vehicle sensor 110 generates travel information about the vehicle. Specifically, the vehicle sensor 110 may be a steering sensor, a gear stage sensor, a brake pedal sensor, an accelerator pedal sensor, or the like, and may generate steering detection information, gear stage detection information, brake pedal detection information, or the like.

In addition, the vehicle sensor 110 generates scan information about the surrounding space of the vehicle. Specifically, the vehicle sensor 110 may be a radar, a Light Detection and Ranging (LiDAR) sensor, a laser sensor, a camera sensor, an ultrasonic sensor, an infrared sensor, or the like, and may generate scan information about the surrounding space according to each sensor.

More specifically, the vehicle sensor 110 used in the embodiment may include an image sensor or camera which is disposed on a vehicle so as to have a field of view for an outside of the vehicle and which is configured to capture image data and include a non-image sensor such as a radar sensor or an ultrasonic sensor which is disposed on the vehicle and configured to capture sensing data to detect one of objects disposed adjacent to the vehicle.

The vehicle sensor 110 may also include a LiDAR sensor configured to transmit a laser signal and process a received signal reflected from an object to calculate shape, distance, and position information about the object.

The vehicle camera according to the present embodiment may be represented by another term such as an image system, a vision system, an image sensor, or the like. The vehicle camera may include a front camera having a field of view in front of the vehicle, a rear camera having a field of view behind the vehicle, and a rear side camera having a field of view to a lateral side or a rear lateral side of the vehicle and may selectively include at least one of the above-described cameras oriented in various directions in some cases.

In particular, the camera, as the vehicle sensor used in the present embodiment, has to generate scan information about the surrounding space of the vehicle. To this end, the camera may be an around view monitoring (AVM) camera capable of photographing images of a wide range of views around the vehicle.

Such cameras may function to capture image data about the surroundings of the vehicle and transmit the captured image data to a processor or a controller. The vision system or the image sensor according to the present embodiment may further include an electronic control unit (ECU) or an image processor having a function of processing the captured image data to generate scan information about the surrounding space of the vehicle and display the generate information on a display or the like.

In addition, the vision system or the image sensor according to present embodiment may further include an appropriate data link or communication link such as a vehicle network bus for data transmission or signal communication from the camera to the image processor.

The vehicle to which the present embodiment is applied may further include a non-image sensor such as a radar sensor or an ultrasonic sensor.

The radar sensor or the radar system employed in the present disclosure as a non-image may include at least one radar sensor unit, for example, at least one of a front detection radar sensor mounted on the front of the vehicle, a rear radar sensor mounted on the back of the vehicle, and side or rear side detection radar sensors mounted on the sides of the vehicle. The radar sensor or radar system may analyze transmitted and received signals to process data, thereby detecting information about an object. To this end, the radar sensor or radar system may include an ECU or a processor. Data transmission or signal communication from the radar sensor to the ECU may be performed through a communication link such as an appropriate vehicle network bus.

The radar sensor includes one or more transmission antennas configured to transmit a radar signal and one or more reception antennas configured to receive a reflected signal received from the object.

The radar sensor according to the present embodiment may adopt a multi-dimensional antenna array and a multiple input multiple output (MIMO) signal transmission/reception scheme to form a virtual antenna aperture larger than an actual antenna aperture.

For example, to achieve horizontal and vertical angular precision and resolution, a two-dimensional antenna array is used. Using the two-dimensional radar antenna array, signals may be transmitted and received by performing two individual (time-multiplexed) scans horizontally and vertically, and MIMO may be used separately from (time-multiplexing of) the two-dimensional radar horizontal and vertical scans.

More specifically, the radar sensor according to the present embodiment may adopt a two-dimensional antenna array configured by a transmission antenna unit including a total of 12 transmission antennas Tx and a reception antenna unit including 16 reception antennas Rx and therefore have an arrangement of 192 virtual reception antennas in total.

In this case, the transmission antenna unit may have three transmission antenna groups each including four transmission antennas, wherein a first transmission antenna group may be spaced apart from a second transmission antenna group by a predetermined distance in the vertical direction, and the first or second transmission antenna group may be spaced apart from a third transmission antenna group by a predetermined distance D in the horizontal direction.

In addition, the reception antenna unit may include four reception antenna groups each including four reception antennas, wherein the reception antenna groups may be arranged to be spaced apart from each other in the vertical direction. The reception antenna unit may be disposed between the first transmission antenna group and the third transmission antenna group, which are spaced apart from each other in the horizontal direction.

In another embodiment, the antennas of the radar sensor may be arranged in a two-dimensional antenna array. For example, each antenna patch may have a rhombus arrangement, thereby reducing unnecessary side lobes.

Alternatively, the two-dimensional antenna array may include a V-shaped antenna array in which a plurality of radiation patches are arranged in a V-shape. More specifically, the two-dimensional antenna array may include two V-shaped antenna arrays. In this case, a single feed is made through the apex of each V-shaped antenna array.

Alternatively, the two-dimensional antenna array may include an X-shaped antenna array in which a plurality of radiation patches are arranged in an X-shape. More specifically, the two-dimensional antenna array may include two X-shaped antenna arrays. In this case, a single feed is made through the center of each X-shaped antenna array.

In addition, the radar sensor according to the present embodiment may employ a MIMO antenna system in order to realize detection accuracy or resolution in vertical and horizontal directions.

More specifically, in the MIMO system, each transmission antenna may transmit a signal having an independent distinct waveform. That is, each transmission antenna transmits a signal of an independent waveform differentiated from the other transmission antennas, and each reception antenna may determine a transmission antenna, from which a reflected signal reflected from an object has been transmitted, based on the different waveforms of the signals.

In addition, the radar sensor according to the present embodiment may include a radar housing configured to accommodate a circuit and a substrate including transmit/reception antennas and may include a radome configured to define an appearance of the radar housing. Here, the radome may be formed of a material which can minimally attenuate transmitted and received radar signals. The radome may be formed using the front and rear bumpers, the grille, the side body of the vehicle, or the outer surface of a vehicle component.

That is, the radome of the radar sensor may be disposed inside the grille, bumper, vehicle body, or the like of the vehicle and may be disposed as a part of a component, such as the grille, bumper, or vehicle part, constituting an outer surface of the vehicle. Thereby, the radome may enhance aesthetics of the vehicle and provide convenience in mounting the radar sensor.

Information such as a distance between the vehicle and the obstacle around the vehicle, a position of the obstacle, and the like may be calculated using the sensing data captured by the non-image sensor. Then, the information may be used to generate scan information about the surrounding space of the vehicle.

An around view camera or ultrasonic sensor, with which the scan information about the surrounding space of the vehicle can be easily generated, may be used among the vehicle sensors according to the present embodiment, but the present disclosure is not limited thereto.

The vehicle sensor 110 may further include a vehicle dynamics sensor disposed on the vehicle to detect information related to travel of the vehicle. As the vehicle dynamics sensor, a steering sensor, a gear stage sensor, a brake pedal sensor, an acceleration pedal sensor, or the like may be used.

The vehicle control apparatus 120 determines whether the trunk 140 is opened. Specifically, the vehicle control apparatus 120 may determine whether the trunk 140 is allowed to be opened based on the travel information about the vehicle and the scan information about the surrounding space of the vehicle. The vehicle control apparatus 120 may generate a control signal for controlling the notifying apparatus 130 and the trunk 140 based on the result of determining whether the trunk 140 is allowed to be opened.

The vehicle control apparatus 120 may be implemented as a controller, an integrated control unit (DCU), or a domain controller that performs functions described below.

The notification apparatus 130 generates a notification signal according to a control signal generated by the vehicle control apparatus 120. Specifically, when the notification apparatus 130 determines that the trunk is allowed to be opened, the notification apparatus 130 may notify the user of the trunk opening allowed state in a visual, audible, or tactile manner according to the control signal generated by the vehicle control apparatus 120. When the notification apparatus 130 determines that the trunk is not allowed to be opened, the notification apparatus 130 may notify the user of the trunk opening disallowed state in a visual, audible, or tactile manner according to the control signal generated by the vehicle control apparatus 120.

In one embodiment, the notification apparatus 130 may be a human machine interface (HMI) mounted on the vehicle. For example, the notification apparatus 130 may be an audio device, a display, or a haptic device mounted on the vehicle.

The trunk 140 is opened according to a control signal generated by the vehicle control apparatus 120. Specifically, when it is determined that the trunk 140 is allowed to be opened, the trunk 140 may be opened according to the control signal generated by the vehicle control apparatus 120. Further, when it is determined that the trunk 140 is not allowed to be opened, the trunk 140 may not be opened according to the control signal generated by the vehicle control apparatus 120.

In addition, the trunk 140 may be opened only when a trunk opening command is input by the user despite the control signal generated by the vehicle control apparatus 120.

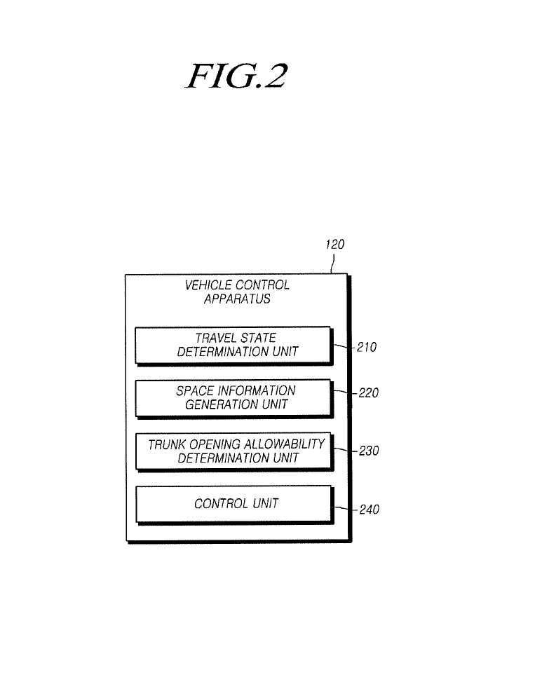

FIG. 2 is a block diagram of a vehicle control apparatus according to an embodiment of the present disclosure.

Referring to FIG. 2, the vehicle control apparatus 120 may include a travel state determination unit 210, a space information generation unit 220, a trunk opening allowability determination unit 230, and a control unit 240.

The travel state determination unit 210 determines the travel state of the vehicle. Specifically, the travel state determination unit 210 may collect travel information about the vehicle from the vehicle sensor 110. The travel state determination unit 210 may determine the travel state of the vehicle based on the collected vehicle travel information.

In one embodiment, the travel state determination unit 210 may determine that the travel state of the vehicle is parking/stop based on the collected vehicle travel information. For example, the travel state determination unit 210 may determine that the travel state of the vehicle is “Parked/Stopped” when gear stage detection information included in the collected vehicle travel information indicates a stage P.

In one embodiment, the travel state determination unit 210 may determine that the travel state of the vehicle is “Parking/Stopping” based on the collected vehicle travel information. For example, when the gear stage detection information included in the collected vehicle travel information indicates a stage R, the travel state determination unit 210 may determine that the vehicle is parking/stopping.

The space information generation unit 220 generates surrounding space information about the vehicle. Specifically, the space information generation unit 220 may collect scan information about the surrounding space of the vehicle from the vehicle sensor 110. The space information generation unit 220 may generate space information about the surrounding space of the vehicle based on the collected scan information.

In one embodiment, the space information generation unit 220 may generate space information including distance information and three-dimensional space information. For example, the space information generation unit 220 may generate space information including a distance between the vehicle and an obstacle, width information, length information, and height information.

In one embodiment, the space information generation unit 220 may generate scan information about the surrounding space of the trunk area where the trunk 140 of the vehicle is located. For example, when the trunk 140 is located at the front portion of the vehicle, the space information generation unit 220 may generate space information about the surrounding space of the front portion of the vehicle. When the trunk 140 is located at the rear portion of the vehicle, the space information generation unit 220 may generate space information about the surrounding space of the rear portion of the vehicle.

The trunk opening allowability determination unit 230 determines whether the trunk is allowed to be opened. Specifically, when it is determined that the travel state of the vehicle is “Parked/Stopped” or “Parking/Stopping,” the trunk opening allowability determination unit 230 may determine whether the trunk is allowed to be opened based on the space information and the trunk size information. The trunk opening allowability determination unit 230 may generate a control signal for controlling the notification apparatus 130 and the trunk 140 according to the result of determining whether the trunk is allowed to be opened.

In one embodiment, the trunk size information refers to information for determining whether the trunk is allowed to be opened, such as a structure, trajectory, size, height, width, and the like related to opening/closing of the trunk 140.

In one embodiment, the trunk opening allowability determination unit 230 may compare the space information with the trunk size information. When there is no possibility that the trunk will strike an obstacle around the vehicle when the trunk is opened, the trunk opening allowability determination unit 230 may determine that the trunk is allowed to be opened. For example, the trunk opening allowability determination unit 230 may compare a distance (space information) between the vehicle and the obstacle with the trunk size information. When the distance between the vehicle and the obstacle is longer than the size of the trunk, the trunk opening allowability determination unit 230 may determine that the trunk is allowed to be opened.

That is, the trunk opening allowability determination unit 230 selects the farthest point on an opening trajectory of the trunk and sets a distance between the vehicle body and the farthest point as a reference distance, namely, the trunk size.

Next, the trunk opening allowability determination unit 230 may calculate a distance from the parking position of the vehicle to an obstacle present on a side to which the trunk is opened and compare the distance to the obstacle with the reference distance. When the distance to the obstacle is shorter than the reference distance, the trunk opening allowability determination unit 230 may determine that the trunk is not allowed to be opened.

In one embodiment, the trunk opening allowability determination unit 230 may further include information about the body size of a user to determine whether the trunk 140 is allowed to be opened. Specifically, when the distance between the vehicle and an obstacle is longer than the sum of the body size of the user and the trunk size (reference distance), the trunk opening allowability determination unit 230 may determine that the trunk is allowed to be opened.

This is intended not only to allow the trunk to be opened but also to secure a space for loading or unloading items into or from the trunk 140 when the user opens the trunk 140.

Even when the distance between the vehicle and the obstacle is shorter than the sum of the body size of the user and the trunk size (reference distance) by a predetermined threshold, it may be determined that the trunk is allowed to be opened.

Generally, when the trunk is fully open, it is possible to access the trunk when the trunk size (i.e., the distance between the most distant point on the opening trajectory of the trunk and the vehicle) and a space smaller than the body size are secured. Therefore, even when the distance between the vehicle and the obstacle is shorter than the sum of the body size of the user and the trunk size (reference distance) by the predetermined threshold, it may be determined that the trunk is allowed to be opened.

The control unit 240 generates a control signal for controlling the notification apparatus 130 and the trunk 140 according to a result of determining whether the trunk is allowed to be opened. Specifically, when it is determined that the trunk 140 is allowed to be opened, the control unit 240 may generate a control signal for controlling the notification apparatus 130 to notify the user that the trunk 140 is allowed to be opened. In addition, when it is determined that the trunk 140 is allowed to be opened, the control unit 240 may generate a control signal for causing the trunk 140 to be opened when a trunk opening command is input from the user.

When it is determined that the trunk 140 is not allowed to be opened, the control unit 240 may generate a control signal for controlling the notification apparatus 130 to notify the user that the trunk 140 is not allowed to be opened. Then, the control unit 240 may generate a control signal for controlling the notification apparatus 130, including information indicating a distance by which the vehicle needs to be moved forward or backward to open the trunk 140. Further, when it is determined that the trunk 140 is not allowed to be opened, the control unit 240 may generate a control signal for controlling the trunk 140 so as not to be opened even when there is a trunk opening command input from the user.

That is, when it is determined that the trunk 140 is not allowed to be opened, the control unit 240 may provide information indicating the distance by which the vehicle needs to be moved forward or backward to open the trunk 140, as well as the fact that the trunk 140 is not allowed to be opened. Thereby, the control unit may allow the driver to further move the vehicle.

In this operation, the control unit 240 may output the information indicating the distance by which the vehicle needs to be moved forward or backward to open the trunk 140 and may control the behavior of the vehicle to move the vehicle forward or backward by the distance when there is an additional movement command from the driver.

In addition, the control unit may receive a trunk opening command from the user using a device, such as a human machine interface (HMI), mounted on the vehicle.

The travel state determination unit 210, the space information generation unit 220, the trunk opening allowability determination unit 230, and the control unit 240 included in the vehicle control apparatus 120 may be integrated to function as one controller, which may include a processor configured to process at least one of image data, which is captured by a camera or an image sensor included in the sensing module, and sensing data captured by a non-image sensor

The controller may determine that the vehicle is parked/stopped, or is to be parked/stopped based on the detection signal of the vehicle sensor, may calculate scan information about the surroundings of the vehicle, and may determine whether the trunk is allowed to be opened based on the scan information. The controller may control the notification apparatus of the vehicle or generate a control signal for opening/closing the trunk depending on whether the trunk is allowed to be opened.

The controller may be implemented as a domain control unit (DCU) or domain controller which integrally has a function of receiving and processing information of a plurality of vehicle sensors or relaying transmission and reception of sensor signals and a function of generating and displaying a notification signal according to the present embodiment or generating a trunk opening control signal and transmitting the control signal to the control unit for opening/closing control the trunk.

The DCU may function to process at least one of the image data captured by the image sensor and the sensing data captured by the non-image sensor and to determine that the vehicle is parked/stopped or is to be parked/stopped based on, at least in part, either processing of the image data captured by the image sensor and processing of the sensing data captured by the non-image sensor, to calculate scan information about the surroundings of the vehicle, to determine whether the trunk is allowed to be opened based on the scan information, and to control the notification apparatus of the vehicle or generating of a control signal for opening/closing the trunk depending on whether the trunk is allowed to be opened. The vehicle control apparatus 120 or the (domain) controller according to the present embodiment as described above, and specific elements for implementing the same, including the travel state determination unit 210, the space information generation unit 220, the trunk opening allowability determination unit 230, and the control unit 240 may be implemented as some modules constituting the vehicle control system according to the present embodiment or some modules of an ECU for the same.

The modules or ECU constituting the vehicle control system may include a processor, a storage device such as a memory, and a computer program capable of performing a specific function. The travel state determination unit 210, the space information generation unit 220, the trunk opening allowability determination unit 230, and the control unit 240 described above may be implemented as software modules capable of performing their own functions.

Since such software can be sufficiently coded by those skilled in the art based on the disclosure set forth in this specification, descriptions of specific software forms will be omitted.

In addition, the vehicle according to the present embodiment as described above may include an autonomous parking system (APS) configured to automatically park the vehicle, or a parking assist system (PAS) configured to assist the driver in parking. The vehicle control apparatus 120 or the (domain) controller according to the present embodiment may be implemented as one function or module of the ECU of the APS or the PAS, or may be implemented as a separate control module capable of controlling the APS or the PAS.

In particular, when the vehicle includes an APS configured to automatically park the vehicle, the vehicle control apparatus 120 according to the present embodiment may consider scan information about the surroundings of the vehicle and information indicating whether the trunk is allowed to be opened in determining a space in which the vehicle is to be parked.

That is, the APS implementing the present embodiment may ultimately determine a parking position where the trunk is allowed to be opened based on the scan information about the surroundings of the vehicle and the information indicating whether the trunk is allowed to be opened and control the vehicle to be parked at the determined parking position. For a mechanism related to detection of a parking space, determination of whether parking is allowed and control techniques such as steering control and vehicle speed control for entry of the vehicle into a parking space in relation to automatic parking, conventional automatic parking techniques may be used. Since those of ordinary skill in the art are familiar with known automatic parking-related techniques, the known automatic parking-related techniques will not be described here in detail.

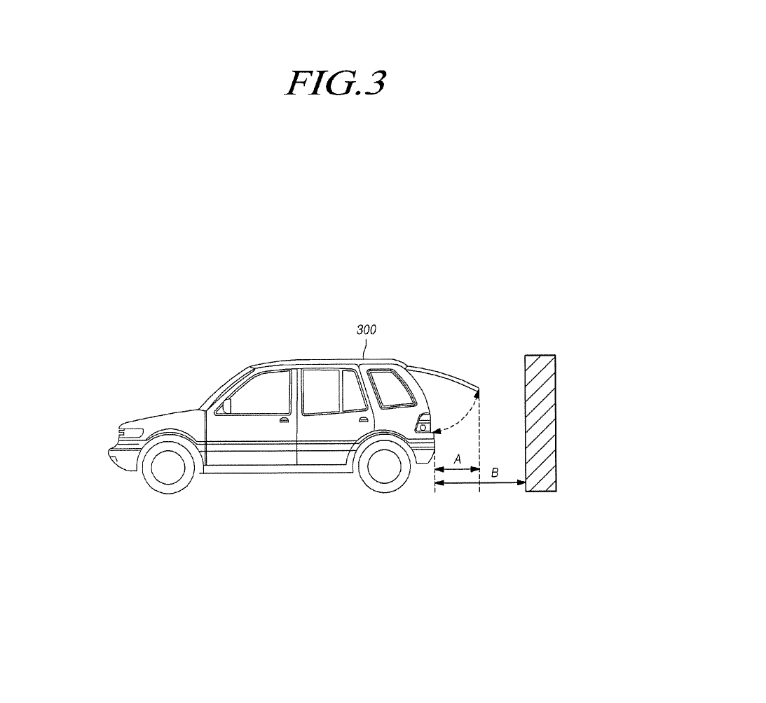

FIG. 3 is a view for explaining an example of determining whether a trunk is allowed to be opened according to an embodiment of the present disclosure.

FIG. 3 illustrates a situation where a driver intends to move a vehicle 300 backward in a state of a gear stage R of the vehicle 300. ‘A’ denotes a distance according to a trajectory followed by the trunk lid when the trunk is opened, and ‘B’ denotes a distance between the vehicle 300 and an obstacle behind the vehicle 300. The vehicle control apparatus 120 compares the distance A and the distance B to determine whether the trunk 140 is allowed to be opened. Specifically, when the distance A is greater than the distance B, the vehicle control apparatus 120 may determine that the trunk 140 is not allowed to be opened because the trunk 140 will strike the obstacle when the trunk 140 is opened. On the other hand, when the distance A is less than the distance B, the vehicle control apparatus 120 may determine that the trunk is allowed to be opened because the trunk 140 will not strike the obstacle when the trunk 140 is opened.

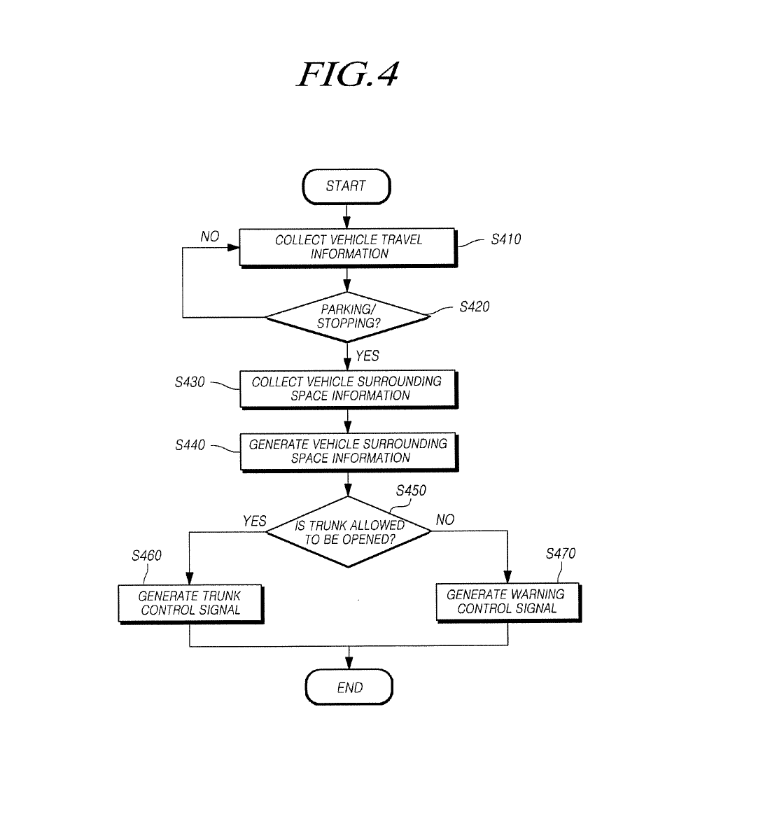

FIG. 4 is a flowchart of a vehicle control method according to an embodiment of the present disclosure.

Hereinafter, the method shown in FIG. 4 will be exemplarily described as being performed by the vehicle control apparatus 120 shown in FIG. 1, and therefore it is apparent that the description of the vehicle control apparatus 120 given above is applied to the method shown in FIG. 4. Further, operations to be described below are not bound to a specific order, and therefore the operations may be performed at the same time, or may be performed one after another.

In operation S410, vehicle travel information is collected. Specifically, the vehicle control apparatus 120 may collect, from the vehicle sensor 110, vehicle travel information for determining a travel state of the vehicle.

In operation S420, whether parking/stopping of the vehicle is occurring is determined. Specifically, the vehicle control apparatus 120 may determine whether the vehicle is parked/stopped or is to be parked/stopped based on the collected travel information about the vehicle. Further, when it is not determined that the vehicle is parked/stopped or is to be parked/stopped, the vehicle control apparatus 120 collects travel information about the vehicle.

In operation S430, the vehicle surrounding space information is collected. Specifically, the vehicle control apparatus 120 may collect scan information about the surrounding space of the vehicle from the vehicle sensor 110.

In operation S440, space information about the surroundings of the vehicle is generated. Specifically, the vehicle control apparatus 120 may generate distance information and three-dimensional information about the surrounding space of the vehicle based on the collected scan information.

In operation S450, whether the trunk is allowed to be opened is determined. Specifically, when it is determined that the vehicle is parked/stopped or is to be parked/stopped, the vehicle control apparatus 120 may determine whether the trunk is allowed to be opened based on the space information and the trunk size information.

In operation S460, a trunk control signal is generated. Specifically, when it is determined that the trunk is allowed to be opened, the vehicle control apparatus 120 may generate a trunk control signal for controlling the trunk 140 to be opened when a trunk opening command is input by the user. In addition, when it is determined that the trunk is allowed to be opened, the vehicle control apparatus 120 may generate a control signal for controlling the notification apparatus 130 to notify the user that the trunk is allowed to be opened.

In operation S470, a warning control signal is generated. Specifically, when it is determined that the trunk is not allowed to be opened, the vehicle control apparatus 120 may generate a warning control signal for controlling the notification apparatus 130 to notify the user that trunk is not allowed to be opened. In addition, when it is determined that the trunk is not allowed to be opened, the vehicle control apparatus 120 may generate a control signal for controlling the trunk 140 such that the trunk 140 is not opened even when a trunk opening command is input by the user.

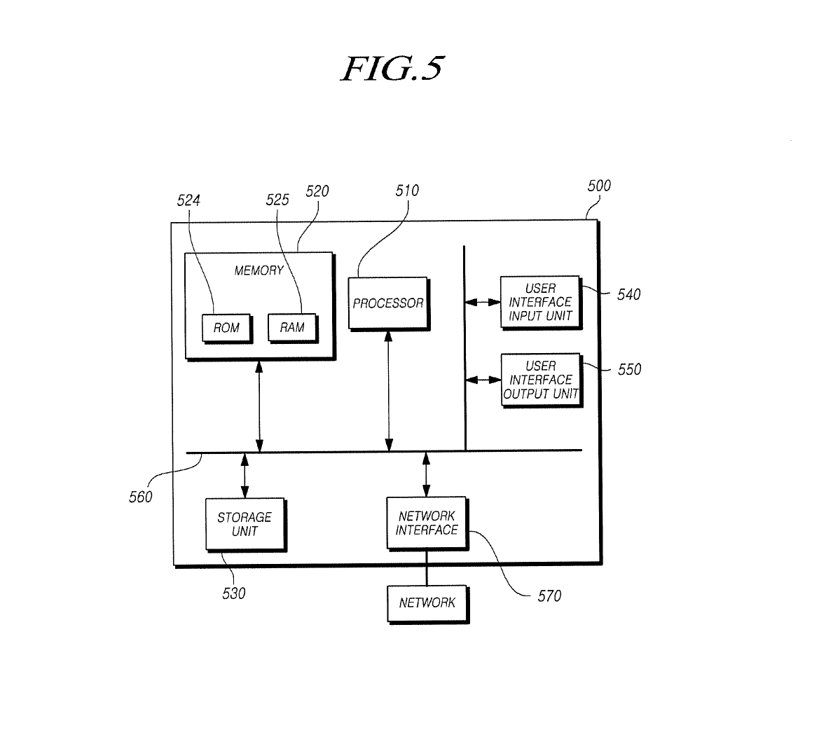

FIG. 5 is a block diagram of a vehicle control apparatus according to another embodiment of the present disclosure.

The embodiments of the present disclosure described above may be embodied in a computer system, for example, on a computer-readable recording medium. As shown in FIG. 5, a computer system 500 for the vehicle control apparatus 120 may include at least one of one or more processors 510, a memory 520, a storage 530, a user interface input unit 540, and a user interface output unit 550, which may communicate with each other via a bus 560. In addition, the computer system 500 may also include a network interface 570 for connecting to a network. The processor 510 may be a central processing unit (CPU) or a semiconductor device configured to execute processing instructions stored in the memory 520 and/or the storage 530. The memory 520 and the storage 530 may include various types of volatile/non-volatile storage media. For example, the memory may include a read-only memory (ROM) 524 and a random access memory (RAM) 525.

Accordingly, the embodiments of the present disclosure may be embodied in a computer-implemented method or in a non-volatile computer storage medium having computer-executable instructions stored thereon. The instructions, when executed by a processor, may implement a method according to at least one embodiment of the present disclosure.

The apparatus and method according to the embodiments of the present disclosure may be implemented in the form of program instructions that may be executed through various computer devices and recorded in a computer-readable medium. The computer-readable medium may include program instructions, data files, or data structures, alone or in combination with each other.

Program instructions to be recorded on a computer-readable medium may be specially designed and constructed for the present disclosure or may be known and available to those of ordinary skill in the computer software art. Examples of computer-readable media include magnetic media such as a hard disk, a floppy disk, and a magnetic tape, optical media such as a compact disc read-only memory (CD-ROM) and a digital versatile disc (DVD), magneto-optical media such as a floptical disk, and hardware devices specially configured to store and execute program instructions such as a ROM, a RAM, and a flash memory. The above-described media may be a transmission media such as light including a carrier wave, metal lines, or wave guides for transmitting a signal designating a program command, a data structure, and the like. Examples of program instructions include machine language code such as that generated by a compiler, as well as high-level language code that may be executed by a computer using an interpreter or the like.

The above-described hardware devices may be configured to operate as one or more software modules to perform the operations of the present disclosure, and vice versa.

The above embodiments of the present disclosure have been described only for illustrative purposes, and those skilled in the art will appreciate that various modifications and changes may be made thereto without departing from the scope and spirit of the disclosure. Therefore, the embodiments of the present disclosure are not intended to limit, but are intended to illustrate the technical idea of the present disclosure, and the scope of the technical idea of the present disclosure is not limited by the embodiments. The scope of the present disclosure shall be construed on the basis of the accompanying claims in such a manner that all of the technical ideas included within the scope equivalent to the claims belong to the present disclosure.

What is claimed is:

1. An apparatus for controlling a vehicle, comprising:
a vehicle sensor comprising at least one of an image sensor disposed on a vehicle to have a field of view for an outside of the vehicle and configured to capture image data and a non-image sensor disposed on the vehicle and configured to capture sensing data to detect at least one of objects disposed adjacent to the vehicle; and
a controller comprising a processor configured to process at least one of the image data captured by the image sensor and the sensing data captured by the non-image sensor,
wherein, in response at least in part to at least one of processing of the image data captured by the image sensor and processing of the sensing data captured by the non-image sensor, the controller generates space information about the vehicle based on scan information about a surrounding space of the vehicle, determines whether a trunk of the vehicle is allowed to be opened based on the generated space information with a travel state of the vehicle being a parked/stopped state or a parking/stopping state, and generates a control signal for controlling at least one of a notification apparatus and the trunk according to a result of determining whether the trunk is allowed to be opened.

2. The apparatus of claim 1, wherein the controller comprises:
a travel state determination unit configured to collect travel information about the vehicle and determine the travel state of the vehicle based on the collected travel information;
a space information generation unit configured to collect the scan information about the surrounding space of the vehicle and generate the space information about the vehicle based on the collected scan information;
a trunk opening allowability determination unit configured to determine whether the trunk of the vehicle is allowed to be opened based on the generated space information when the travel state of the vehicle is determined to be the parked/stopped state or the parking/stopping state; and
a control unit configured to generate a control signal for controlling at least one of the notification apparatus and the trunk according to the result of determining whether the trunk is allowed to be opened.

3. The apparatus of claim 2, wherein, when gear stage detection information included in the collected travel information indicates a reverse stage (a stage R), the travel state determination unit determines that the travel state of the vehicle is the parking/stopping state.

4. The apparatus of claim 2, wherein the space information generation unit generates the space information corresponding to at least one of a distance between the vehicle and an obstacle and a three-dimensional space based on the collected scan information.

5. The apparatus of claim 2, wherein the space information generation unit is configured to:
collect scan information about a surrounding space of a trunk area where the trunk is located in the vehicle; and
generate space information about the surrounding space of the trunk area.

6. The apparatus of claim 2, wherein the trunk opening allowability determination unit determines whether the trunk of the vehicle is allowed to be opened by comparing the generated space information with information about a trajectory of the trunk formed when the trunk is opened.

7. The apparatus of claim 6, wherein the trunk opening allowability determination unit further comprises information about a body size of a user to determine whether the trunk is allowed to be opened.

8. The apparatus of claim 7, wherein the trunk opening allowability determination unit is configured to:
set a distance between a most distant point on the trajectory formed when the trunk is opened and a body of the vehicle as a reference distance;
calculate a distance to an obstacle present on a side to which the trunk is opened; and
determine that the trunk is allowed to be opened when the distance to the obstacle is determined to be less than a sum of the body size of the user and the reference distance by a predetermined threshold.

9. The apparatus of claim 2, wherein, when it is determined that the trunk is allowed to be opened, the control unit is configured to:
generate a control signal for notifying a user that the trunk is allowed to be opened, as the control signal for controlling the notification apparatus; and
generate a control signal for controlling the trunk to be opened, as the control signal for controlling the trunk when a trunk opening command is input by the user.

10. The apparatus of claim 2, wherein, when it is determined that the trunk is not allowed to be opened, the control unit is configured to:
generate a control signal for notifying the user that the trunk is not allowed to be opened, as the control signal for controlling the notification apparatus; and
generate a control signal for controlling the trunk not to be opened even when a trunk opening command is input by the user, as the control signal for controlling the trunk.

11. The apparatus of claim 10, wherein, when it is determined that the trunk is not allowed to be opened, the control unit further generates information indicating a movement distance, by which the vehicle needs to be moved forward or backward to open the trunk, and provides the information to the notification apparatus.

12. A method of controlling a vehicle, the method comprising:
collecting travel information about a vehicle from a vehicle dynamics sensor disposed on the vehicle to detect information related to travel of the vehicle and determining a travel state of the vehicle based on the collected travel information;
collecting scan information about a surrounding space of the vehicle using a vehicle sensor comprising at least one of an image sensor disposed on the vehicle to have a field of view for an outside of the vehicle and configured to capture image data and a non-image sensor disposed on the vehicle and configured to capture sensing data to detect at least one of objects disposed adjacent to the vehicle and generating space information about the vehicle based on the collected scan information;
when the travel state of the vehicle is determined to be a parked/stopped state or a parking/stopping state, determining whether a trunk of the vehicle is allowed to be opened based on the generated space information; and
generating a control signal for controlling at least one of a notification apparatus and the trunk according to a result of the determining of whether the trunk is allowed to be opened.

13. The method of claim 12, wherein the determining of the travel state comprises, when gear stage detection information included in the collected travel information indicates a reverse stage (a stage R), determining that the travel state of the vehicle is the parking/stopping state.

14. The method of claim 12, wherein the generating of the space information comprises generating the space information corresponding to at least one of a distance between the vehicle and an obstacle and a three-dimensional space based on the collected scan information.

15. The method of claim 12, wherein the determining of whether the trunk is allowed to be opened comprises:
comparing the generated space information with information about a trajectory of the trunk formed when the trunk is opened; and
determining whether the trunk is allowed to be opened.

16. The method of claim 15, wherein the determining of whether the trunk is allowed to be opened comprises further including body size information about a user and determining whether the trunk is allowed to be opened.

17. The method of claim 16, wherein the determining of whether the trunk is allowed to be opened comprises:
setting a distance between a most distant point on the trajectory formed when the trunk is opened and a body of the vehicle as a reference distance;
calculating a distance to an obstacle present on a side to which the trunk is opened; and
determining that the trunk is allowed to be opened when the distance to the obstacle is determined to be less than a sum of the body size of the user and the reference distance by a predetermined threshold.

18. The method of claim 12, wherein, when it is determined that the trunk is not allowed to be opened, the generating of the control signal comprises:
generating a control signal for notifying the user that the trunk is not allowed to be opened, as the control signal for controlling the notification apparatus; and
generating a control signal for controlling the trunk not to be opened even when a trunk opening command is input by the user, as the control signal for controlling the trunk.

19. The method of claim 18, wherein, when it is determined that the trunk is not allowed to be opened, the generating of the control signal comprises:
generating information indicating a movement distance by which the vehicle needs to be moved forward or backward to open the trunk; and
providing the information to the notification apparatus.

20. An apparatus for controlling a vehicle, comprising:
a vehicle sensor comprising at least one of an image sensor disposed on a vehicle to have a field of view for an outside of the vehicle and configured to capture image data and a non-image sensor disposed on the vehicle and configured to capture sensing data to detect at least one of objects disposed adjacent to the vehicle;
a vehicle dynamics sensor disposed on the vehicle to detect information related to travel of the vehicle;
an autonomous parking system (APS) configured to control the vehicle to move to a parking position by controlling a behavior of the vehicle or a parking assist system (PAS) configured to assist a driver in parking the vehicle; and
a domain controller configured to process at least one of the image data captured by the image sensor and the sensing data captured by the non-image sensor and configured to control the APS or the PAS,
wherein, in response at least in part to at least one of processing of the image data captured by the image sensor and processing of the sensing data captured by the non-image sensor, the domain controller generates space information about the vehicle based on scan information about a surrounding space of the vehicle, determines whether a trunk of the vehicle is allowed to be opened based on the generated space information with a travel state of the vehicle being a parked/stopped state or a parking/stopping state, and generates a control signal for controlling at least one of a notification apparatus and the trunk according to a result of determining whether the trunk is allowed to be opened.

21. The apparatus of claim 20, wherein the domain controller finally determines a parking position at which the trunk is allowed to be opened and controls the APS or the PAS to control the vehicle to be parked in the parking position.
